(19) United States
(12) Patent Application Publication
(10) Pub. No.: US 2009/0249087 A1
(43) Pub. Date: Oct. 1, 2009

(54) Power Event Indicator for Managed Memory Device

(76) Inventors: Nir Jacob Wakrat, San Jose, CA (US); Mark Alan Helm, Santa Cruz, CA (US)

Correspondence Address: FISH & RICHARDSON P.C., PO BOX 1022, MINNEAPOLIS, MN, 55440-1022, US

(21) Appl. No.: 12/193,593

(22) Filed: Aug. 18, 2008

Related U.S. Application Data
(60) Provisional application No. 61/039,397, filed on Mar. 25, 2008.

(51) Int. Cl. G06F 1/30; G06F 12/02

(52) U.S. Cl. 713/300; 711/103; 711/E12.008

(57) ABSTRACT

A host device coupled to a managed memory device (e.g., a managed NAND device) generates a signal indicative of an expected power event. The signal is received by the managed memory device which performs one or more operations in response to the signal. In some implementations, a pin is added to a power management chip that provides a signal to interrupt the managed memory device when a power event (e.g., power failure, system reset) is expected to occur. The signal provides the managed memory device time to finish one or more operations (e.g., the last physical operation) and to place the managed memory device in a known and/or safe state prior to the occurrence of the power event.

### RELATED APPLICATION

This application claims the benefit of priority from U.S. Provisional Application No. 61/039,397, for “Power Event Indicator for Managed Memory,” filed Mar. 25, 2008, which provisional application is incorporated by reference herein in its entirety.

### TECHNICAL FIELD

This subject matter is generally related to power management.

### BACKGROUND

Flash memory is a type of electrically erasable programmable read-only memory (EEPROM). Because flash memories are nonvolatile and relatively dense, they are used to store files and other persistent objects in handheld computers, mobile phones, digital cameras, portable music players, and many other devices in which other storage solutions (e.g., magnetic disks) are inappropriate. One challenge facing flash memory devices is unexpected power failures. This challenge is even greater if the power loss occurs during a write operation. For NAND devices with multi-level cell architectures, a power failure can corrupt previously written pages.

### SUMMARY

A host device coupled to a managed memory device (e.g., a managed NAND device) generates a signal indicative of an expected power event. The signal is received by the managed memory device which performs one or more operations in response to the signal. In some implementations, a pin is added to a power management chip that provides a signal to interrupt the managed memory device when a power event (e.g., power failure, system reset) is expected to occur. The signal provides the managed memory device time to finish one or more operations (e.g., the last physical operation) and to place the managed memory device in a known and/or safe state prior to the occurrence of the power event.

### DESCRIPTION OF DRAWINGS

FIG. 1 is a block diagram illustrating an example power management system for a managed memory device.

FIG. 2 is a flow diagram of an example power management process performed by the system of FIG. 1.

### DETAILED DESCRIPTION

### System Overview

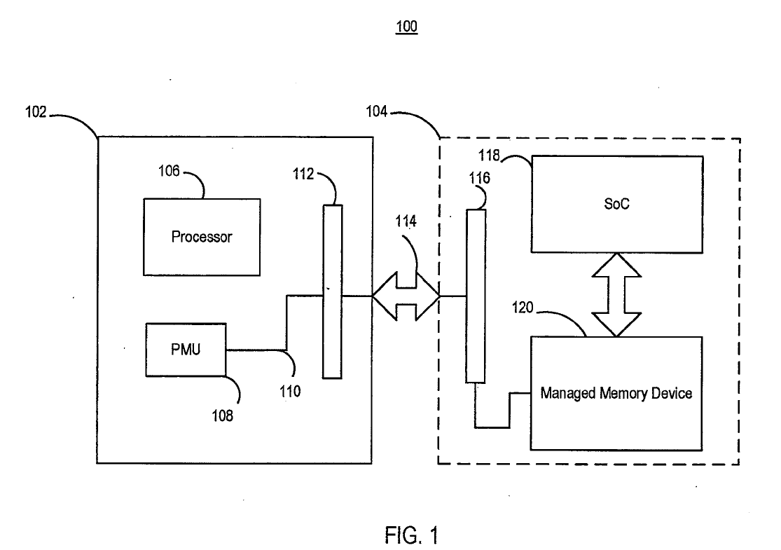

FIG. 1 is a block diagram illustrating an example power management system 100 for a managed memory device. In some implementations, a host device 102 is coupled to a memory system 104 through external bus 114. The host device 102 can include a processor 106 a power management unit (PMU) 108, internal bus 110 and interface 112. The memory system 104 can include a system on chip (SoC) 118, a managed memory device 120 (e.g., managed NAND, SSD) and an interface 116.

The PMU chip 108 can be a microcontroller that governs power functions for the host device 102. The PMU chip 108 can include firmware and software, memory, a CPU, input/output functions, timers to measure intervals of time, as well as digital to analog converters to measure the voltages of a battery or other power source of the host device 102. The PMU chip 108 can remain active even when the host device 102 is completely shut down and is powered by a backup battery. For portable devices, the PMU chip 108 can be responsible for coordinating many functions, including: monitoring power connections and battery charges, charging batteries when necessary, controlling power to other integrated circuits, shutting down unnecessary system components when they are left idle, controlling sleep and power functions (on and off), managing an interface for built in keypad, touchpad, touch screen and track pads on portable devices and computers and regulating a real-time clock. In some implementations, the PMU chip 108 can run diagnostics on various power-related operations and check the diagnostics against current energy-saver settings, allowing the PMU chip 108 to actively manage power consumption for optimum user performance.

In some implementations, the PMU chip 108 can determine an expected power event and generate a signal indicative of the power event. Some examples of power events are power failures (e.g., a power drop) or system resets. In the configuration shown, the signal can be generated by circuitry inside the PMU chip 108 in expectation of a power event. The signal can be transmitted at a one or more pins of the PMU chip 108. For example, the PMU chip 108 can be coupled to a power source for the host device and can include circuitry for detecting a power failure or system reset. Upon detection, the PMU chip 108 can raise or lower the voltage level on a pin of the PMU chip 108 (e.g., using a bootstrap resistor).

The pin can be coupled to the memory system 104 through the internal bus 110 and interface 112. The signal can be transmitted over the external bus 114 (e.g., an Open NAND Flash Interface (ONFI, ATA)), received by circuitry in the interface 116, and then passed to the managed memory device 120. Responsive to the signal, the managed memory device 120 can perform one or more operations. For example, the managed memory device 120 can finish a last physical operation to place the managed memory device 120 in a known and/or safe state.

An example managed memory device 120 is managed NAND. Managed NAND integrates both NAND flash memory and a controller device that can handle error correction code (ECC) and other housekeeping operations associated with using the memory. By handling these complexities on the Managed NAND device itself, the host device processor 106 can focus on running an operating system and software applications.

The SoC 118 can integrate several components of a computer or other electronic system into a single integrated circuit chip. For example, the SoC 118 can contain digital, analog, mixed-signal, and radio-frequency functions in a single chip. In some implementations, the SoC 118 can include one or more microcontrollers, microprocessors or digital signal processing (DSP) cores, memory blocks including one or more of ROM, RAM, EEPROM and/or Flash, timing sources including oscillators and phase-locked loops, peripherals including counter-timers, real-time timers and power-on reset generators, external interfaces including industry standards such as USB, FireWire, Ethernet, USART, SPI, analog interfaces including analog to digital converters (ADCs) and digital to analog converters (DACs), voltage regulators and PMUs. These blocks can be connected by either a proprietary or industry-standard bus (e.g., AMBA bus developed by ARM Inc.). In some implementations, the SoC 118 includes a controller and other circuitry for reading and writing to the managed memory device 120. The SoC 118 can also be coupled to the interface 116 for receiving the power event signal from the host device 102. In some implementations, the SoC 118 can reset the managed memory device 120 in response to commands from the PMU chip 108.

### Example Process

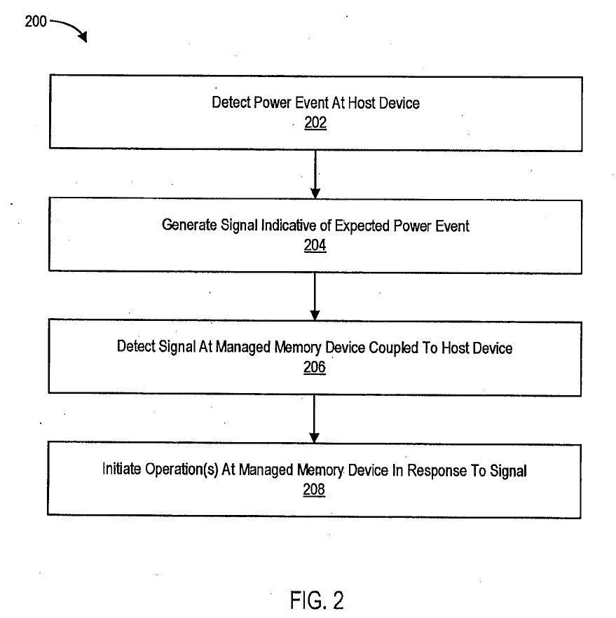

FIG. 2 is a flow diagram of an example power management process 200 performed by the system 100 of FIG. 1. In some implementations, the process 200 can begin by detecting or determining a power event at a host device (202). The host device can generate a signal indicative of an expected power event (204). For example, a PMU chip in the host device can apply or change a voltage level on one or more pins of the PMU chip. The signal can be received at a managed memory device coupled to the host device (206). In response to receiving the signal, the managed memory device can initiate one or more operations in the managed memory device (208). For example, the managed memory device can finish a last physical operation to ensure a known and/or safe state of the managed memory device. The known and safe state helps prevent pages from being corrupted or other errors from occurring, particularly during write operations.

Referring again to FIG. 1, the process 200 can be illustrated by an example scenario where a user resets a portable media player with managed NAND. When the user resets the media player, a PMU in the media player predicts that a SoC in a memory system of the media player will reset, causing power to be cycled for both the SoC and the managed NAND. An example chain of events can be as follows:
1. User resets media player.
2. PMU shuts down power to SoC chip and PMU chip signals managed NAND that power is about to drop.
3. The PMU waits x milliseconds before commanding the SoC to reset to allow time for the managed NAND to finish the current or last physical operation (e.g., a write operation), thus leaving the physical NAND in a known and/or safe state.
4. The managed NAND is powered off by the PMU.
5. The SoC chip and Managed NAND are powered on again by the PMU.

This foregoing chain of events is exemplary and other events are possible depending on the application and devices used.

A number of implementations have been described. Nevertheless, it will be understood that various modifications may be made. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
determining an expected power event at a host device coupled to a managed memory device;
generating a signal indicative of the power event; and
providing the signal to the managed memory device.

2. The method of claim 1, where the power event is a power failure or a reset command.

3. The method of claim 1, where the managed memory device is a managed NAND device or Solid State Drive (SSD).

4. The method of claim 1, where generating a signal indicative of the power event includes changing a voltage level of the signal.

5. The method of claim 1, where the signal is generated by a power management unit in the host device.

6. A method comprising:
receiving a signal at a managed memory device coupled to a host device, the signal indicative of an expected power event at the host device; and
performing one or more operations at the managed memory device in response to the signal.

7. A system comprising:
a processor of a host device operable for determining an expected power event at the host device and for generating a signal indicative of the power event; and
an interface coupled to the processor and to a managed memory device, the interface operable for providing the signal to the managed memory device.

8. The system of claim 7, where the managed memory device is managed NAND or a Solid State Drive (SSD).

9. The system of claim 7, where the host device is one of a smart phone or media player.

10. A managed memory device, comprising:
an interface operable for receiving a signal from a host device coupled to the managed memory device, the signal indicative of an expected power event at the host device; and
performing one or more operations at the managed memory device in response to the signal.
